(19) United States
(12) Patent Application Publication
(10) Pub. No.: US 2023/0349051 A1
(43) Pub. Date: Nov. 2, 2023

(54) METHOD FOR DISSOLVING METAL OXIDES FROM LIFE SCIENCES EQUIPMENT

(71) Applicant: TECHNOCHIM SA, Ghislenghien (BE)

(72) Inventors: Frédéric GROULARD, Cambron-Saint-Vincent (BE); Juliette LOUCHE, Ville-Pommeroeul (BE); Coraline CLAEYS, Ghoy (BE)

(73) Assignee: TECHNOCHIM SA, Ghislenghien (BE)

(21) Appl. No.: 18/140,752

(22) Filed: Apr. 28, 2023

(30) Foreign Application Priority Data
Apr. 29, 2022 (EP) 22170851.4

(51) Int. Cl. C23G 1/19; C23G 1/08; C11D 3/04; C11D 3/00; C11D 11/00

(52) U.S. Cl. CPC C23G 1/19; C11D 3/0042; C11D 3/042; C11D 3/044; C11D 3/046; C11D 11/0029; C23G 1/081; C23G 1/085

(57) ABSTRACT

The present invention is in the field of chemical cleaning and surface treatments for a stainless steel substrate. In particular, the present invention provides a method, kit and use of specific solutions for removing rouging (class I, II and/or III) and/or blacking from a stainless steel substrate, which may be used as processing station or production unit.

### CROSS-REFERENCE TO RELATED APPLICATIONS

This patent application claims the benefit of foreign priority to European Patent Application No. 22170851.4 filed on Apr. 29, 2022, the disclosure of which is herein incorporated by reference in its entity.

### TECHNICAL FIELD

The present invention is in the field of chemical cleaning and surface treatments for a stainless steel substrate. In particular, the present invention provides a method, kit and use of specific solutions for removing rouging (class I, II and/or III) and/or blacking from a stainless steel substrate, which may be used as processing station or production unit.

### BACKGROUND

Various industries such as the pharmaceutical, food and biotechnological industries use systems and units (e.g. vats, vessels, generators, machines, etc.) for the production and processing of their products. These systems and units typically consist of stainless steel substrates produced from stainless steel alloys, such as chromium/nickel/molybdenum steels. Despite the use of high quality materials after a while discolorations appear on the stainless steel substrate’s surface which come in contact with products and processing media (e.g. water or other solutions). These discolorations are a form of corrosion and typically the result of films or deposits on the stainless steel surfaces, such as Fe oxides particles or Cr, Ni and Mo components.

At an early stage the discolorations show a fine reddish colour and are thus referred to as “rouging”. Class I rouging typically originates from external sources such as erosion or cavitation, whereas class II rouging can be explained as a breakdown of the passive layer inducing a corrosion of the stainless steel surfaces. It could be enhance by chloride. However, in some cases a more intense form of rouging will show a dark blue to black colour instead, and may be referred to as “blacking”. The latter class III rouging is typically found in high temperature steam systems.

Although the exact cause of rouging is not yet entirely understood, it is believed that the colour variation is a result of the oxide/hydroxide/carbonate type and variations in the water of hydration associated with the corrosion products. Consequently, the rouging is closely linked to and dependent on the materials used and the thermodynamic conditions to which these materials are exposed. Depending on the operating intensity and conditions, these surface changes can occur as early as a few months after a unit is first started up. In other cases, it may be years until the rouging is first observed.

For example, it is frequently observed in the pharmaceutical industry that stainless steel surfaces tend to develop a red to black thick surface layer upon contact with hot (above 50° C.) purified water (vapour or liquid) having an electrolytic conductivity less than 1 µS/cm. For instance, the surfaces of Water-For-Injection equipment inspected after 6 to 18 months often show the so-called rouging effects, i.e. the presence of an increased concentration of iron oxide on the surface. Apart from iron oxide, mixed metal oxides are also present such as iron-chrome-nickel mixed metal oxides.

Rouging presents a danger in the industry since it leads to the release of heavy metal oxide particles from the stainless steel surface. This may result in undesired contamination of products (e.g. pharmaceuticals) with heavy metal particles, and thereby negatively affect the purity and quality of products and their processing. Furthermore, rouging increases the micro-roughness of affected stainless steel surfaces and reduces the efficiency of the used systems and units. As a result thereof, the rouging has to be removed periodically to ensure high quality and purity of products.

There exist various methods and machines to remove rouging. However, mechanical cleaning processes (e.g. by wiping with a cloth) are limited to easily accessible areas and loosely adhering particles. Such processes are thus not suitable to remove more permanent discolorations at harder to reach areas, as well adhering films and deposits. For this purpose, wet-chemical cleaning processes are used almost exclusively. For example, WO 2009/095,475 and US 8,192,550 describe the use of cleaning solutions and methods for removing rouging from stainless steel surfaces. Additionally, treatments that delay or reduce the formation of rouging may also be applied. For example, EP 3 249 076 describes products for the preventive treatment of stainless steel and related methods.

However, the presently available products and methods are still found lacking when aiming to completely remove rouging, or require the use of strong and highly concentrated mineral acids despite the numerous known disadvantages for the systems. In particular intense class III rouging is known to be particularly difficult to completely remove, requiring the use of extremely costly, laborious and often difficult to perform treatments.

For instance, when handled improperly, the cleaning solutions can lead to considerable danger, both with respect to its transport and disposal. In addition the cleaning solutions do not specifically target the rouging, but also partly dissolve the heavy metals additionally present in the alloy of the stainless steel. Thus, when handled improperly, there is the danger that the surface of the process stations and production units is attacked and the surface properties are negatively affected. Moreover, their use as a component of the cleaning solution itself is also dangerous for the handlers as its vapours can cause severe respiratory irritations.

In view of the above there is a need for novel methods and products to efficiently and completely remove rouging and/or blacking, in particular class III rouging.

### SUMMARY

The invention according to the present disclosure solves the aforementioned problems. Accordingly, provided herein are a method, kit and use of specific solutions for removing any class of rouging (I, II and III) and/or blacking from a stainless steel substrate, which may be used as processing station or production unit. The method, kit and use may be particularly effective for removing class III rouging, which is typically the most difficult to remove rouging class.

In a first aspect the invention generally relates to a method for removing rouging and/or blacking from stainless steel, the method comprising the steps of successively contacting a stainless steel substrate with the following solutions:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disuphite or any of the corresponding salts and/or a combination thereof and a complexing agent selected from one or more carboxylic acids.

Preferably, the method is for removing class III rouge formation on a stainless steel substrate.

In a further aspect the invention generally relates to a kit for removing rouging and/or blacking from stainless steel, the kit comprising:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

Preferably, the kit is for removing class III rouge formation on a stainless steel substrate.

In a further aspect the invention generally relates to a use of at least two solutions for removing rouging and/or blacking from stainless steel, the use comprising:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

Preferably, the use is for removing class III rouge formation on a stainless steel substrate.

In some preferred embodiments the first solution comprises the oxidizing agent in a concentration of at least 0.1 g/l to at most 100.0 g/l, preferably 0.1 to 64.0 g/l, more preferably 0.5 to 45.0 g/l, most preferably 0.5 g/l to 10.0 g/l.

In some preferred embodiments the oxidising agent is selected from KMnO₄, NH₄MnO₄, Ca(MnO₄)₂, NaMnO₄, AgMnO₄, KBrO₃; preferably KMnO₄.

In some preferred embodiments the first solution comprises HNO₃ and/or H₂SO₄ as acid preferably in a concentration of at least 1.0 g/l to at most 50.0 g/l, preferably 2.0 g/l to 40.0 g/l, more preferably 3.0 g/l to 30.0 g/l, more preferably 4.0 g/l to 20.0 g/l, most preferably 5.0 g/l to at most 10.0 g/l.

In some preferred embodiments the second solution comprises the reducing agent in a concentration ranging from at least 1.0 g/l to at most 100.0 g/l; preferably 5.0 to 75.0 g/l; more preferably 7.5 g/l to 60.0 g/l, most preferably 10.0 g/l to 50.0 g/l.

In some preferred embodiments the second solution comprises NaOH and/or KOH as base in a concentration of at least 1.0 g/l to at most 200.0 g/l, preferably 1.0 g/l to 150.0 g/l, more preferably 1.0 g/l to 100.0 g/l, most preferably 1 g/l to at most 75 g/l.

In some preferred embodiments the complexing agent is selected from one or more carboxylic acids chosen from a compound comprising diacetic, triacetic and/or tetraacetic acid groups or salts thereof.,

In some preferred embodiments the first solution has a pH equal to or below 4.0, preferably a pH equal to or below 3.0, more preferably a pH equal to or below 2.5, most preferably a pH equal to or below 2.0.

In some preferred embodiments the second solution is an alkaline solution having a pH of 7.0 to 14.0, preferably 7.0 to 13.0, more preferably 7.5 to 12.0, most preferably 7.5 to 11.0

In some preferred embodiments the first has a temperature of 80° to 100° C. during contacting with the steel substrate, preferably from 85° to 100° C., more preferably from 90° to 100° C., and most preferably from 90° to 95° C.

In some preferred embodiments the second solution has a temperature of 80° to 100° C. during contacting with the steel substrate, preferably from 80° to 95° C., more preferably from 80° to 90° C., and most preferably from 80° to 85° C.

In some preferred embodiments wherein the contacting time of the stainless steel substrate with the first solution is from 1.0 hour to 4.0 hours, preferably from 1.0 hour to 3.0 hours, more preferably from 1.0 hour to 2.0 hours, and most preferably about 2.0 hours for the first solution.

In some preferred embodiments wherein the contacting time of the stainless steel substrate with the second solution is from is from 0.50 hours to 4.0 hours, preferably from 0.5 hour to 3.0 hours, more preferably from 0.50 hours to 1.5 hours, and most preferably about 1.5 hour for the second solution.

In some preferred embodiments between each contacting step the substrate is rinsed with a rinsing fluid; preferably an aqueous rinsing fluid having a conductivity (electrolytic) of at most 1 µS/cm.

### DESCRIPTION OF THE FIGURES

The following description of the figures of specific embodiments of the invention is only given by way of example and is not intended to limit the present explanation, its application or use. In the drawings, identical reference numerals refer to the same or similar parts and features.

FIGS. 1A and 1B shows three (A, B, C) exemplary cut-out stainless steel substrates before and after treatment with the present invention. The experimental details are discussed further in the examples.

### DESCRIPTION OF THE INVENTION

As used below in this text, the singular forms “a”, “an”, “the” include both the singular and the plural, unless the context clearly indicates otherwise.

The terms “comprise”, “comprises” as used below are synonymous with “including”, “include” or “contain”, “contains” and are inclusive or open and do not exclude additional unmentioned parts, elements or method steps. Where this description refers to a product or process which “comprises” specific features, parts or steps, this refers to the possibility that other features, parts or steps may also be present, but may also refer to embodiments which only contain the listed features, parts or steps.

The enumeration of numeric values by means of ranges of figures comprises all values and fractions in these ranges, as well as the cited end points.

The term “approximately” as used when referring to a measurable value, such as a parameter, an amount, a time period, and the like, is intended to include variations of +/- 10% or less, preferably +/-5% or less, more preferably +/-1% or less, and still more preferably +/- 0.1% or less, of and from the specified value, in so far as the variations apply to the invention disclosed herein. It should be understood that the value to which the term “approximately” refers per se has also been disclosed.

All references cited in this description are hereby deemed to be incorporated in their entirety by way of reference.

Unless defined otherwise, all terms disclosed in the invention, including technical and scientific terms, have the meaning which a person skilled in the art usually gives them. For further guidance, definitions are included to further explain terms which are used in the description of the invention.

The present invention provides a method, kit and use of specific solutions for removing any class of rouging (I, II and III) and/or blacking from a stainless steel substrate, which may be used as processing station or production unit. The method, kit and use may be particularly effective for removing class III rouging, which is typically the most difficult to remove rouging class.

The present invention is based on the surprising finding that a combined use of at least two solutions applied in a specific order may result in a complete removal of the rouging and/or blacking deposit, or at least a considerably improved removal of rouging deposit relative to known products and methods. Moreover, following removal any formation of rouging deposits thereafter may be prevented or at least considerably delayed. The present invention is particularly suitable for treatment of class III rouging, which is typically very difficult and cumbersome to remove. Moreover, the present invention has the advantage that the removal and/or preventative treatment can be executed in the presence of atmospheric oxygen and/or at normal operating conditions (e.g. pressure) without the need for disassembly of the stainless steel device or apparatus.

The terms “rouging” or “rouge”, and “rouging film”, “rouging formation” or “rouging deposit” are used interchangeably herein and generally refer to a special form of deposits that occur on stainless steel surfaces, in particular on surfaces made from austenitic stainless steel substrates in hot systems or in ultrapure vapor systems, which typically comprise iron oxide-or iron hydroxide-dominated layers which typically comprise intercalated Cr, Ni and Mo or their oxides. These porous and particle-forming rouging layers rich in iron oxide, usually have a layer thickness between 0.1 µm and 10 µm and whose nature is that of a flat corrosion, replace the originally present dense and strong passive layers rich in chromium oxide. The class III rouging may also be referred to as “blacking” or “black film”. Common thickness for rouging is between 200 nm and 1000 nm, although some substrates may have rouging layers of 2500 nm or greater.

As used herein the term “substrate” referred to in the different aspects of the present invention is an iron or iron alloy substrate. Preferably it is a stainless steel substrate. For instance, it is a CrNi or a CrNiMo steel. Examples of CrNi and CrNiMo steels are steels of grades AISI 304 (1.4301), AISI 304L (1.4307, 1.4306), AISI 316 (1.4401), AISI 316L (1.4404, 1.4435), AISI316Ti (1.4571), or AISI 904L (1.4539) [according to DIN 10027-2]. Examples of stainless steel substrates that can be treated according to aspects of the present invention are mixing vats, storage containers, fermenters, recipient vessels, dryers, filling machines, sterilization vessels, freeze dryers, autoclaves, washing machines, ultrapure water generators, ultrapure vapour generators, distribution lines for purified or ultrapure fluids, and others.

As used herein the term “metal oxide” refers to iron (II) and/or iron (III) oxides and/or hydroxides, rouge (such as class I rouge, class II rouge, or class III rouge), and/or spinels such as iron (II-III) oxides wherein optionally part of the iron atoms are replaced by chromium, nickel, molybdenum and/or silicon atoms.

As used herein the term “solution” refers, in the widest sense of the word, to a liquid mixture in which the component or components as listed are uniformly distributed within a solvent (e.g. water).

As used herein the term “pH” refers a scale of acidity ranging from 0 to 14. In particular, a neutral solution may be understood to have a pH of about 7 (for example 6.9, 7.0 or 7.1), an acidic solutions has a pH below 7 (for example 6.5, 6.0, 5.0, 4.0,etc.) and an alkaline solutions has a pH above 7 (for example 7.5, 8.0, 9.0, 10.0, etc.). The indicative pH values and pH ranges listed in any one embodiment of any of the solutions (e.g. first and/or second) correspond with the pH value prior to contact with a (stainless steel) substrate. It is understood that chemical reactions with rouging deposit and/or any residues or compounds present on the substrate may result in a shifting of the pH during contacting, thereby potentially lowering or increasing the pH value of the solution.

In a first aspect the invention generally relates to a method for removing rouging and/or blacking from stainless steel, the method comprising the steps of successively contacting a stainless steel substrate with the following solutions:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

Generally speaking, the method provides for a treatment of a stainless steel substrate affected by rouging and/or blacking, which is typically deposited on the surface of said stainless steel substrate. By successively applying the two listed solutions in the order as indicated above it was observed that rouging and/or blacking could be removed with an efficiency that goes beyond the application of any one of the two solutions separately. Accordingly, a synergistic effect could be observed, which achieves a unique function going beyond the expected effects for each of the listed solutions. Indeed, the present method may provide for a complete removal or at the very least for significantly improved removal of rouging and/or blacking when compared to state of art methods and products. Additionally, the method can be performed at relatively low cost, labour, and time, which may in turn increase the operational lifetime and reduce the required downtimes of the systems and devices affected by rouging, and may in turn also improve the quality of products produced using said system and devices. In some preferred embodiments the method is for removing class III rouge formation on a stainless steel substrate. Although the present method may be considered suitable for removing class I and class II rouging with very high efficiency, i.e. removing any traces of rouging and/or blacking, it was observed that the present method may be particularly effective at removing class III rouging as well, which is typically a very difficult and costly process. Elimination of class III rouging is more delicate due to its different structure and chemical composition. Using state of art methods there is a high risk of damaging the surface state during cleaning or delivering suboptimal results by only reducing the class III rouging thickness and still leaving behind traces of rouging. However, application of the method as described herein may result in complete removal of class III rouging without damaging the steel substrate.

Additionally, sometimes steel substrates are simultaneously affected by different rouging and/or blacking types, for example class I and class II, class I and class III or class II and class III. Such cases may require supplementary treatments, for instance by combining or sequencing state of art methods. However, application of the method as described may result in complete removal of the different rouging types without the need for separate devices, products or methods for each rouging type.

The solutions are brought into contact with the rouging deposit on the steel substrate. In some embodiments the contacting is performed by dipping, flushing, or spraying. Preferably the stain steel substrate is completely covered by the solution. This may allow for complete removal of rouging in difficult to reach areas, such as in the vicinity of corners or apertures. The dipping, flushing, or spraying may be performed with additional tools, such a spray can or similar tools.

In some embodiments the solutions are drained between each contacting step; this may prevent mixing of the subsequent solutions. In some embodiments the stainless steel substrate is rinsed with a rinsing fluid between each contacting step. Preferably the rinsing fluid is an aqueous rinsing fluid having an electrolytic conductivity of at most 1 µS/cm. Preferably, the rinsing fluid is drained prior to the next contacting step. Optionally the steel substrate may be rinsed prior to performing the method, for instance to remove any remaining dirt, dust or various chemical products present on said substrate.

In a further aspect the invention generally relates to a kit for removing rouging and/or blacking from stainless steel, the kit comprising:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

In some preferred embodiments the kit is for removing class III rouge formation on a stainless steel substrate. Optionally, the kit comprises instructions for performing the method according to any embodiments as described herein. Optionally, the kit comprises tools to improve the performing the method; for instance, gloves, sprays, vials, and so on. In some embodiments the kit comprises a rinsing fluid; preferably an aqueous rinsing fluid having an electrolytic conductivity of at most 1 µS/cm.

In a further aspect the invention generally relates to a use of at least two solutions for removing rouging and/or blacking from stainless steel, the use comprising:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

In some preferred embodiments the use is for removing class III rouge formation on a stainless steel substrate. The use may be for systems and units (e.g. vats, vessels, generators, machines, etc.) for the production and processing of products, such as in the pharmaceutical, food and biotechnological industries.

The first solution is an acidic solution comprising a permanganate and/or bromate compound or any of the corresponding salts as oxidizing agent. According to the method as described herein, the first solution is to be applied prior to the second solution. The first solution may provide the following effects : (i) an oxidizing effect, by putting metallic compounds in a oxidized state; and/or (ii) a weakening effect, by weakening the oxide layer. Optionally, other solutions may be applied prior to contacting the substrate with the first solution, such as a rinsing fluid to remove any particles or chemical compounds that may be present on the steel substrate and could cause undesired chemical reactions.

The first solution may be of any acidic pH value below 6.5. An acidic pH may allow for stabilizing the oxidizing agent and preventing issues of oxidizing agent deposition. In some preferred embodiments the first solution has a pH equal to or below 4.0, preferably a pH equal to or below 3.0, more preferably a pH equal to or below 2.5, most preferably a pH equal to or below 2.0, for example 3.5; for example 2.5; for example 1.5. In a most preferred embodiment, the very high acidic pH values may, for instance, more efficiently stabilise KMnO₄ and prevent MnO₂ deposition.

The first solution comprises at least a strong oxidizing agent; an oxidizing agent is defined herein as a substance having the ability to oxidize other substances. Strong oxidising agents typically have a high (+) oxidation state, such as +5 or +7, allowing for greater absorption of electrons. Preferably the oxidizing agent is a permanganate and/or bromate compound or any of the corresponding salts. Preferably the oxidising agent is selected from KMnO₄ (potassium permanganate), NH₄MnO₄ (Ammonium permanganate), Ca(MnO₄)₂ (Calcium permanganate), NaMnO₄ (Sodium permanganate), AgMnO₄ (Silver permanganate); KBrO₃ (Potassium Bromate) and/or a combination thereof; most preferably the oxidizing agent is KMnO₄.These listed oxidising agents were observed to provide for a particularly efficient embodiment of the first solution. In some embodiments the first solution comprises the oxidizing agent, preferably KMnO₄, in a concentration of at least 0.1 g/l to at most 100.0 g/l, preferably 0.1 to 64.0 g/l (max solubility of KMnO₄ in water at 20° C.), more preferably 0.5 to 45.0 g/l, most preferably 0.5 g/l to 10.0 g/l. It was observed that the presence of the oxidizing agent, such as KMnO₄, in the preferred ranges may further improve the efficiency of the first contacting step. The first solution may comprise a (strong) acid with a pKa-value of less than zero; a strong acid is defined herein as having a pKa-value of less than zero. Preferably the acid is HNO₃ (nitric acid), which has a pKa value of -1.4, and/or H₂SO₄ (sulfuric acid), which has a pKa value of -2.8. The listed acids were observed to provide for particularly efficient embodiments of the first solution. In some embodiments the first solution comprises the acid, preferably HNO₃ and/or H₂SO₄, in a concentration of at least 1.0 g/l to at most 50.0 g/l, preferably 2.0 g/l to 40.0 g/l, more preferably 3.0 g/l to 30.0 g/l, more preferably 4.0 g/l to 20.0 g/l, most preferably 5.0 g/l to at most 10.0 g/l, for example: 1.0 g/l; for example 2.0 g/l; for example 3.0 g/l; for example 4.0 g/l; for example 5.0 g/l; for example 6.0 g/l; for example 7.0 g/l; for example 8.0 g/l; for example 9.0 g/l; for example 10.0 g/l. It was observed that the presence of HNO₃ and/or H₂SO₄ in the preferred ranges may further improve the efficiency of the first contacting step.

The listed concentration ranges were observed to provide for a particularly efficient embodiment of the first solution.

In some embodiments the first solution comprises HNO₃ and a permanganate compound, preferably KMnO₄, NH₄MnO₄, Ca(MnO₄)₂, NaMnO₄, AgMnO₄. In some embodiments the first solution comprises H₂SO₄ and a permanganate compound, preferably KMnO₄, NH₄MnO₄, Ca(MnO₄)₂, NaMnO₄, AgMnO₄. In some embodiments the first solution comprises HNO₃ and a bromate compound, preferably KBrO₃. In some embodiments the first solution comprises H₂SO₄ and a bromate compound, preferably KBrO₃. In some preferred embodiments the first solution comprises HNO₃ and KMnO₄. In some preferred embodiments the first solution comprises H₂SO₄ and KMnO₄.

In some embodiments the first solution has a temperature of 80° to 100° C. during contacting with the steel substrate, preferably from 85° to 100° C., more preferably from 90° to 100° C., and most preferably from 90° to 95° C.; for example 91° C., 92° C., 93° C. or 94° C. The contacting temperature may be adjusted depending on the degree of rouging and/or blacking. Contacting the substrate in the preferred temperature ranges may result in improved efficiency of the first solution, potentially reducing the time and the amount of first solution necessary for performing the method. In some embodiments the contacting time of the stainless steel substrate with the first solution is from 0.5 hours to 4.0 hours, preferably from 1.00 hour to 4.0 hours, more preferably from 1.0 hours to 3 hour, even more preferably from 1.0 hour to 2.0 hours, and most preferably about 2.0 hours. The contacting time may be adjusted depending on the degree of rouging and/or blacking. However, applying the first solution in the preferred time ranges may result in an optimal balance between efficient rouging and/or blacking removal and time costs (e.g. downtime of apparatus or system). In a most preferred embodiment the first solution contacts the steel substrate from 1.0 hours to 2.0 hours at a temperature ranging from 90° to 95° C.

The second solution is a solution comprising a reducing agent selected from dithionite (Na₂S₂O₄), sulphite (or sulfite), bisulphite (or bisulfite), disulphite (or disulfite) and/or any of its corresponding salts and a complexing agent selected from one or more carboxylic acids preferably selected from a compound comprising diacetic, triacetic and/or tetraacetic acid groups or salts thereof. As used herein the complexing agent is preferably selected from oxalic acid or a salt thereof, gluconic acid or a salt thereof, ethylenediaminetetraacetic acid (EDTA) or a salt thereof, nitrilotriacetic acid (NTA) or a salt thereof, and/or phosphonic acid or a salt thereof.

According to the method as described herein, the second solution is to be applied after the first solution. The second solution may reduce the metals present in the oxide layer of the substrate, such as chromium and iron. Optionally the second solution may comprise one or more surfactants.

The second solution may be of any neutral or alkaline pH value ranging from about 7.0 up to 14.0. Alkaline solutions may provide a more stable media for the reducing agent, thereby improving the effectiveness of the second solution, but neutral solutions were observed to work as well. In some preferred embodiments the second solution is an alkaline solution having a pH of 7.0 to 14.0, preferably 7.0 to 13.0, more preferably 7.5 to 12.0, most preferably 7.5 to 11.0; for example 7.5; for example 8.5 ; for example 10.0. In a most preferred embodiment, the alkaline pH values may, for instance, more efficiently stabilise dithionite.

In some embodiments the second solution comprises any one or a combination of the listed reducing agents in a concentration ranging from at least 1.0 g/l to at most 100.0 g/l; preferably 5.0 to 75.0 g/l; more preferably 7.5 g/l to 60.0 g/l, most preferably 10.0 g/l to 50.0 g/l; for example 10 g/l; for example 20 g/l; for example 30 g/l; for example 40 g/l. Preferably, the second solution comprises dithionite in a concentration ranging from at least 1.0 g/l to at most 100.0 g/l; preferably 5.0 to 75.0 g/l; more preferably 7.5 g/l to 60.0 g/l, most preferably 10.0 g/l to 50.0 g/l. It was observed that the presence of dithionite in the preferred ranges may further improve the efficiency of the second contacting step.

In some embodiments the second solution comprises a strong base (i.e. a base having a pKa-value of at least 12); preferably the base is NaOH and/or KOH. Preferably the second solution comprises NaOH and/or KOH in a concentration ranging from at least 1 g/l to at most 200 g/l, preferably 1 g/l to 150 g/l, more preferably 1 g/l to 100 g/l, most preferably 1 g/l to at most 75 g/l; for example: 5 g/l; for example 15 g/l; for example 25 g/l; for example 35 g/l; for example 45 g/l; for example 55 g/l; for example 65 g/l; for example 75 g/l. It was observed that the presence of NaOH and/or KOH in the preferred ranges may further improve the efficiency of the second contacting step. In some preferred embodiments wherein the oxidising agent is dithionite and wherein the base is NaOH, the dithionite concentration is at least 35 g/l and the NaOH concentration is at least 5 g/l.

The listed concentration ranges were observed to provide for a particularly efficient embodiment of the second solution.

In some embodiments the second solution has a temperature of 80° to 100° C. during contacting with the steel substrate, preferably from 80° to 95° C., more preferably from 80° to 90° C., and most preferably from 80° to 85° C.; for example 81° C., 82° C., 83° C. or 84° C. The contacting temperature may be adjusted depending on the degree of rouging. Contacting the substrate in the preferred temperature ranges may result in improved efficiency of the second solution, potentially reducing the time and the amount of second solution necessary for performing the method. In some embodiments the contacting time of the stainless steel substrate with the second solution is from 0.50 hours to 4.0 hours, preferably from 0.5.00 hour to 3.0 hours, more preferably from 0.5 hours to 2 hours, even more preferably from 0.50 hours to 1.5 hours, and most preferably about 1.5 hours. In a most preferred embodiment the second solution contacts the steel substrate from 0.5 hours to 1.5 hours at a temperature ranging from 80° to 85° C.

In a preferred embodiment, the method, kit and/or use comprise the following solutions: (i) a first solution comprising an acid with a pKa-value of less than zero and a permanganate and/or a bromate compound as oxidizing agent; and (ii) a second alkaline solution comprising a base with a pKa-value of at least 13, and a reducing agent selected from dithionite, sulphite, bisulphite, disulphite or any of the corresponding salts and/or a combination thereof and a complexing agent selected from one or more carboxylic acids.

In a preferred embodiment, the method, kit and/or use comprise the following solutions: (i) a first solution comprising HNO₃ and/or H₂SO₄, and a permanganate and/or a bromate compound as oxidizing agent; and (ii) a second alkaline solution comprising NaOH and/or KOH, and a reducing agent selected from dithionite, sulphite, bisulphite, disulphite or any of the corresponding salts and/or a combination thereof and a complexing agent selected from one or more carboxylic acids.

In an exemplary embodiment, the method, kit and/or use comprise the following solutions:

(i) a first solution comprising HNO₃ and KMnO₄; and (ii) a second alkaline solution comprising NaOH, dithionite and a complexing agent. In another exemplary embodiment, the method, kit and/or use comprise the following solutions: (i) a first solution comprising HNO₃ and NH₄MnO₄; and (ii) a second alkaline solution comprising NaOH, sulphite and a complexing agent.

In an exemplary embodiment, the method, kit and/or use comprise the following solutions:

(i) a first solution comprising H₂SO₄ and KMnO₄; and (ii) a second alkaline solution comprising NaOH, dithionite and a complexing agent. In another exemplary embodiment, the method, kit and/or use comprise the following solutions: (i) a first solution comprising H₂SO₄ and NH₄MnO₄; and (ii) a second alkaline solution comprising NaOH, sulphite and a complexing agent.

### EXAMPLES

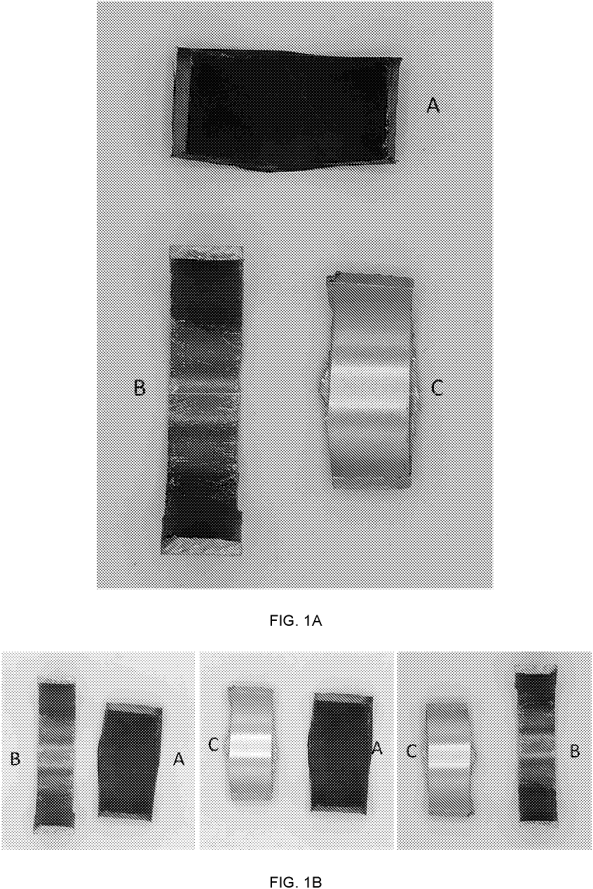

Reference is made to FIG. 1A and FIG. 1B. The figure shows three cut-out stainless steel substrates from the same industrial piping equipment. The first untreated stainless steel substrate (A) shows clear blacking.

The second stainless steel substrate (B) has been treated with a three-step treatment step including the successive treatment with
(1) a first alkaline solution comprising 45 g/l NaOH and 5 g/l KMnO₄ for 3 hours at a temperature between 90 to 95° C.,
(2) a second alkaline solution comprising 35 g/l dithionite, 5 g/l NaOH and 1 g/I oxalic acid for 1.5 hours at a temperature between 80 to 85° C. and
(3) a third solution comprising 2.0×10⁻² mol/I of complexing anions and 5.0×10⁻⁵ mol/I of Fe²⁺ for 2 hours at a temperature between 85 to 90° C.

As a result of the treatment some blacking has been removed although still the sample is not fully been deblacked.

The third stainless steel substrate (C) has been treated with a two-step treatment step according to the present invention, namely with
(1) a first acidic solution comprising 10 g/l HNO₃ and 1 g/l KMnO₄ for 2 hours at a temperature between 90 to 95° C., and
(2) a second neutral solution comprising 35 g/l dithionite, 5 g/l NaOH and 1 g/l oxalic acid for 1.5 hours at a temperature between 80 to 85° C. As a result of this treatment the substrate has been fully deblacked and has a grey metallic appearance.

To conclude, it was surprisingly found that a treatment according to the present invention results in a complete removal of any rouging and/or blacking deposits from the stainless steel substrate.

1. A method for removing rouging and/or blacking from stainless steel, the method comprising the steps of successively contacting a stainless steel substrate with the following solutions:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

2. A kit for removing rouging and/or blacking from stainless steel, the kit comprising:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

3. Use of at least two solutions for removing rouging and/or blacking from stainless steel, the use comprising:
(i) a first acidic solution comprising a permanganate and/or bromate compound or any of the corresponding salts as oxidizing agent and nitric and/or sulfuric acid; and;
(ii) a second neutral or alkaline solution comprising a reducing agent selected from dithionite, sulphite, bisulphite, disulphite or any of the corresponding salts and/or a combination thereof and a complexing agent selected from one or more carboxylic acids.

4. The method according to claim 1, wherein the first solution comprises the oxidizing agent in a concentration of at least 0.1 g/l to at most 100.0 g/l, preferably 0.1 to 64.0 g/l, more preferably 0.5 to 45.0 g/l, most preferably 0.5 g/l to 10.0 g/l.

5. The method according to claim 1, wherein the oxidising agent is selected from KMnO₄, NH₄MnO₄, Ca(MnO₄)₂, NaMnO₄, AgMnO₄, and KBrO₃; preferably KMnO₄.

6. The method according to claim 1, wherein the first solution comprises HNO₃ and/or H₂SO₄ as acid preferably in a concentration of at least 1.0 g/l to at most 50.0 g/l, preferably 2.0 g/l to 40.0 g/l, more preferably 3.0 g/l to 30.0 g/l, more preferably 4.0 g/l to 20.0 g/l, most preferably 5.0 g/l to at most 10.0 g/l.

7. The method according to claim 1, wherein the second solution comprises the reducing agent in a concentration ranging from at least 1.0 g/l to at most 100.0 g/l; preferably 5.0 to 75.0 g/l; more preferably 7.5 g/l to 60.0 g/l, most preferably 10.0 g/l to 50.0 g/l.

8. The method according to claim 1, wherein the second solution comprises NaOH and/or KOH as base in a concentration of at least 1.0 g/l to at most 200.0 g/l, preferably 1.0 g/l to 150.0 g/l, more preferably 1.0 g/l to 100.0 g/l, most preferably 1.0 g/l to at most 75.0 g/l.

9. The method according to claim 1, wherein the first solution has a pH equal to or below 4.0, preferably a pH equal to or below 3.0, more preferably a pH equal to or below 2.5, most preferably a pH equal to or below 2.0.

10. The method according to claim 1, wherein the second solution is an alkaline solution having a pH of 7.0 to 14.0, preferably 7.0 to 13.0, more preferably 7.5.0 to 12.0, most preferably 7.5 to 11.0.

11. The method according to claim 1, wherein the first solution has a temperature of 80° to 100° C. during contacting with the steel substrate, preferably from 85° to 100° C., more preferably from 90° to 100° C., and most preferably from 90° to 95° C. and/or wherein the second solution has a temperature of 80° to 100° C. during contacting with the steel substrate, preferably from 80° to 95° C., more preferably from 80° to 90° C., and most preferably from 80° to 85° C.

12. The method according to claim 1, wherein the contacting time of the stainless steel substrate with the first solution is from 0.5 hours to 4.0 hours, preferably from 1.00 hour to 4.0 hours, more preferably from 1 hours to 3 hours, even more preferably from 1.00 hours to 2.0 hours, and most preferably about 2.0 hours and/or wherein the contacting time of the stainless steel substrate with the second solution is from 0.50 hours to 4.0 hours, preferably from 0.5 hour to 3 hours, more preferably from 0.50 hours to 2 hours, even more preferably from 0.5 hours to 1.5 hours, and most preferably about 1.5 hours.

13. The method according to claim 1, wherein between each contacting step the substrate is rinsed with a rinsing fluid; preferably an aqueous rinsing fluid having a conductivity of at most 1 µS/cm.

14. The method according to claim 1 for removing class III rouge formation on a stainless steel substrate.

15. The method according to claim 1, wherein said complexing agent is a compound comprising diacetic, triacetic and/or tetraacetic acid groups or salts thereof.
